(19) United States
(12) Patent Application Publication
(10) Pub. No.: US 2009/0124190 A1
(43) Pub. Date: May 14, 2009

(54) CEILING AIR DEFLECTOR INSERT AND METHOD OF ASSEMBLY

(75) Inventors: John W. Barfield, Ann Arbor, MI (US); Jingqiu Mei, Northville, MI (US)

Correspondence Address: PEARNE & GORDON LLP, 1801 EAST 9TH STREET, SUITE 1200, CLEVELAND, OH, 44114-3108, US

(73) Assignee: T.C. AIRTECH, INC., Northville, MI (US)

(21) Appl. No.: 11/909,845

(22) PCT Filed: Mar. 31, 2006
(86) PCT No.: PCT/US06/11717

§ 371 Date: Sep. 27, 2007

Related U.S. Application Data
(60) Provisional application No. 60/666,960, filed on Mar. 31, 2005.

(51) Int. Cl. F24F 13/08; B23P 19/04

(52) U.S. Cl. 454/292; 29/700

(57) ABSTRACT

A square deflector insert for a drop ceiling made of four identical sides that can be simply field assembled and installed. In contrast to previous single-piece inserts, the new inserts provide much more compact packaging for shipping but can be assembled quickly just before installation. Although described in terms of a square deflector the invention is applicable to other polygonal shapes.

### BACKGROUND OF THE INVENTION

The field of the invention pertains to ceiling air deflectors used primarily for forced air heating and ventilating systems in commercial structures, such as large retail stores. In particular, the invention pertains to air deflectors that fit in a modular manner into square or rectangular grid suspended ceilings.

A particular example of such an air deflector is illustrated in U.S. Pat. No. 6,745,518 wherein an air deflector is positioned in a standard 2-foot by 2-foot grid suspended ceiling. This patent is directed to an add-on air deflector insert to solve a problem that has arisen from the air deflectors.

Eventually, the air flow from air deflectors deposits dirt, soot and other particulates on the ceiling (usually white) around the air deflector. The result is an unsightly dirty area about the air deflector that is difficult to clean and usually must be re-painted. The air deflector insert of the above patent comprises a single-piece square fin that extends downwardly from the grid and surrounds the air deflector. The square fin deflects air moving from the air deflector away from the ceiling immediately surrounding the air deflector, thereby diminishing the accumulation of particulates on the ceiling over time.

With a view to further improving the deflector insert, the applicant has developed the following improvements.

### SUMMARY OF THE INVENTION

The air deflector insert of the above patent is a single integral frame which requires considerable bulk to package and ship for its actual weight. In contrast, by manufacturing four separate identical component pieces, the package size can be greatly reduced, or six or more inserts can be packaged in the same size package as a single-piece insert. Disclosed below are examples of corner connections applicable to the four separate identical pieces that permit the air deflector insert to be assembled in less than a minute, on-site, just before installation.

### BRIEF DESCRIPTION OF THE DRAWINGS

FIG. 1 illustrates in perspective a ceiling air deflector insert;

FIG. 2 shows a ceiling air deflector insert in plan view;

FIG. 3 is a side view of a ceiling air deflector;

FIG. 4 is an inside elevation of a single side piece;

FIG. 5 is a cross-section taken along the line A-A in FIG. 4 showing the attachment means;

FIG. 6 is a plan view of the side piece of FIG. 4

FIG. 7 is an outside elevation of the side piece of FIG. 4, the side piece having been rotated 180° from the view in FIG. 4;

FIG. 8 is a detail of the complementary attachment means at the opposite end of the side piece from the attachment means shown in FIG. 5;

FIG. 9 illustrates in perspective an alternative attachment between two side pieces, and

FIG. 10 illustrates in perspective a second alternative attachment between two side pieces.

### DESCRIPTION OF THE PREFERRED EMBODIMENT

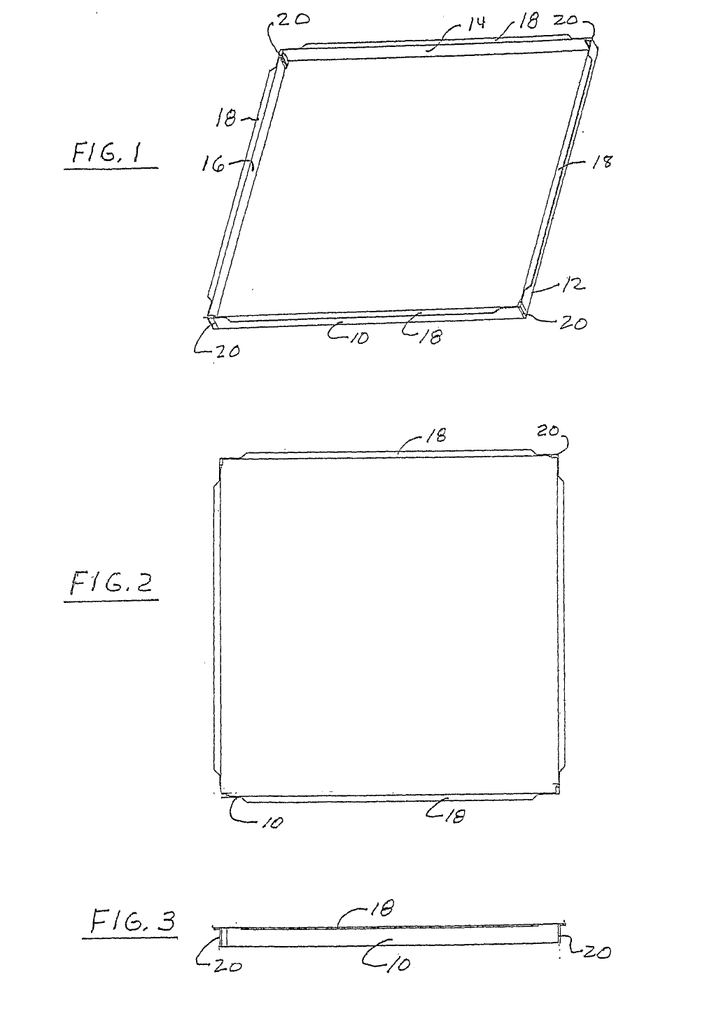

Illustrated in FIGS. 1, 2 and 3 is a fully assembled air deflector insert having four side pieces 10, 12, 14 and 16 that are identical to form a square shape. Each side piece 10 to 16 extends downwardly from a separate flange 18, the flange being adapted to rest on the 2′×2′ grid members of a typical suspended or drop ceiling in common use in commercial structures. Other sizes and shapes of air deflectors are in use or can be envisioned, therefore other sizes and shapes to encircle the air deflector with an air deflector insert can be envisioned.

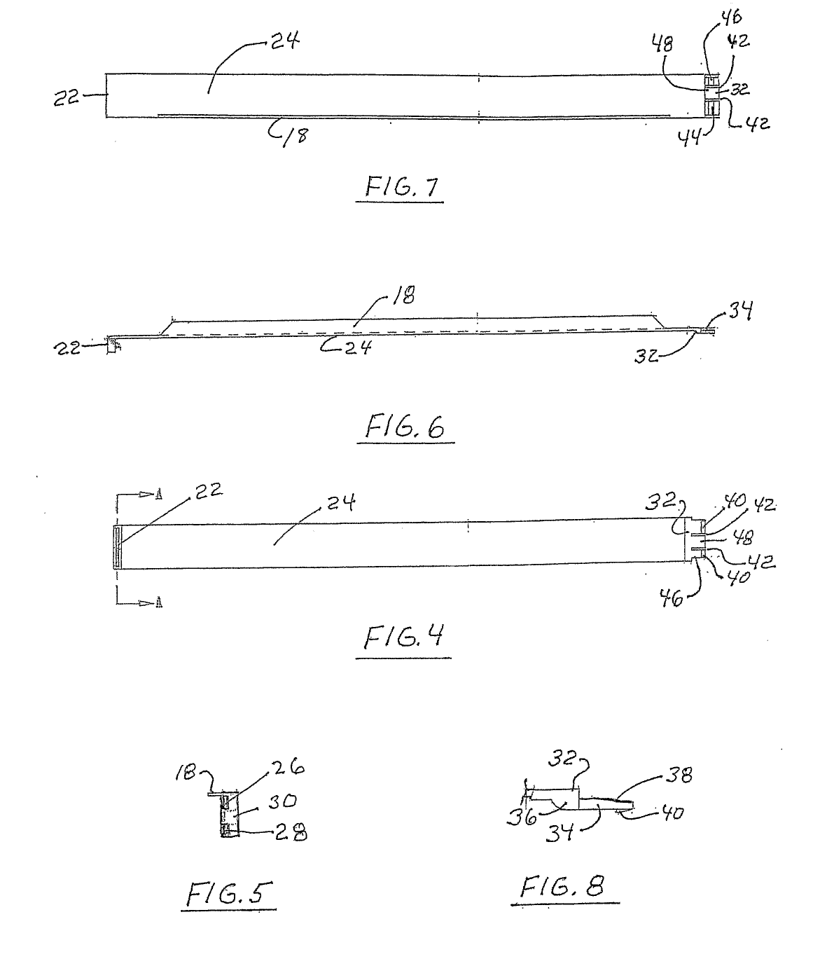

At one end of each side piece 10 to 16 are attachment means 20, such as the rectangular socket 22 extending perpendicularly from the side 24 as shown in FIGS. 4 and 6 to the left. In the detail of FIG. 5 the socket 22 includes a latching feature comprising upper 26 and lower 28 openings in the inside 30 of the socket.

At the other end of each side piece 10 to 16 are complementary attachment means 32 such as the tongue 34 extending from the side 24 as shown to the right in FIGS. 4, 6 and 7. The tongue 34 extends generally parallel to the side 24 but offset 36 as best shown in FIG. 8. The tongue 34 is slightly tapered 3S on one side and formed with a cusp 40 on the other side.

The tongue 34 is split by slots 42 forming an upper tongue 44, lower tongue 46 and middle tongue 48. The upper tongue 44 is sized vertically with its cusp 40 to match the upper opening 26 in the socket 22. Likewise, the lower tongue 46 with its cusp 40 is sized vertically to match the lower opening 28 in the socket 22. Upon insertion of the tongue 34 of one side piece into the socket 22 of another side piece properly, the cusps match the openings 26 and 28 and the attachment snaps together to permanently latch the side pieces together.

If one of the side pieces is misoriented relative to the other side piece, both tongues 44 and 46 will be misaligned to the upper and lower openings 26 and 28 and not properly snap together.

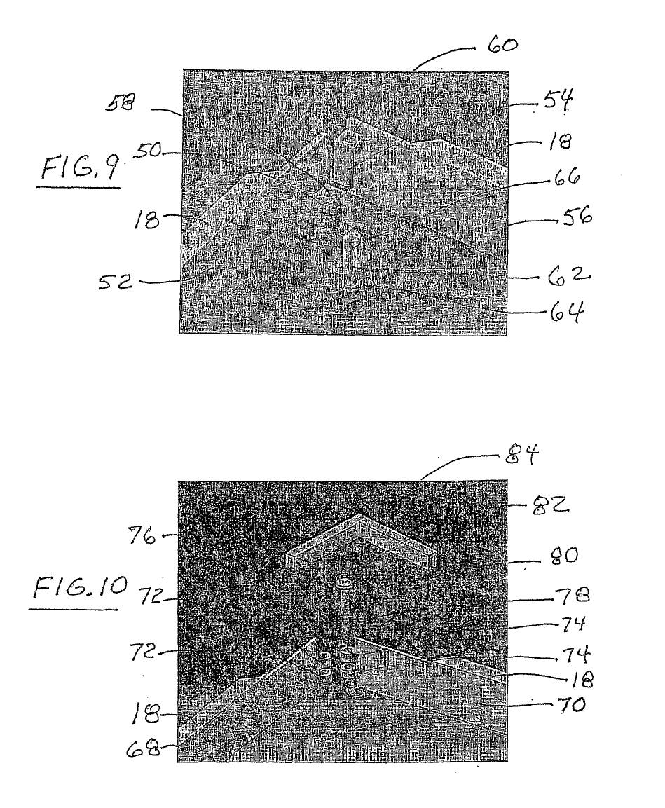

In FIG. 9 an alternative form of the attachment means comprises a protrusion 50 from the inside sidewall 52 and a complementary protrusion 54 from a next adjacent inside sidewall 56. Each protrusion may be integral with its respective sidewall or separately attached thereto. The protrusions 50 and 54 are pierced by holes 58 and 60 respectively. When the attachment means is brought together, the holes 55 and 60 are in axial alignment and a pin 62 can be inserted therethrough to join the sidewalls 52 and 56 together. Pin 62 is headed 64 as shown and has an interference fit with hole 60 to permanently join the sidewalls together. The pin 62 may be forked 66 to aid in inserting the pin with an interference fit.

FIG. 10 illustrates another pinned attachment means. Each sidewall 68 and 70 includes a pair of protrusions 72 and 74 which complementarily nest together as shown. The protrusions 72 and 74 are pierced by holes 76 and 78 respectively that axially align when the attachment means is joined together by a pin 80. The pin 80 is headed 82 and locked in place by a corner bracket 84 which fits over the sidewall 68 and 70 edges adjacent the corner and attachment means. The corner bracket 84 may provide for an interference fit with the sidewalls or be adhesively attached for a permanent assembly of the attachment means.

1. An air deflector insert mountable in an opening formed by grid members in a suspended grid ceiling, said insert comprising four sides, each having a downwardly extending air deflecting portion and an integral generally horizontally extending means adapted to at least partially support the side on an adjacent grid member, each side having attachment means at one end and complementary attachment means at the other end whereby the four sides can be joined at four corners by hand manipulation, with the attachment means being manually connected to next adjoining side complementary attachment means.

2. The air deflector insert of claim 1, wherein the attachment means and the complementary attachment means snap together to join.

3. The air deflector insert of claim 1 wherein the attachment means and the complementary attachment means include a pin to join together.

4. The air deflector insert of claim 3 wherein the pin is sized to create an interference fit in the attachment means.

5. The air deflector insert of claim 3 including a corner bracket to lock the pin in the attachment means.

6. An air deflector insert component mountable in an opening formed by grid members in a suspended grid ceiling, said component comprising a longitudinal side for deflecting air downwardly and integral means extending along at least a portion of the side adapted to at least partially support the side on an adjacent grid member, the side having two ends, attachment means at one end of the side and means complementary to the attachment means at the other end of the side, whereby a plurality of such sides can be attached together by manually connecting the attachment means to the complementary attachment means to form the corners of a polygonal shaped air deflector.

7. The air deflector insert component of claim 6 wherein the attachment means comprise at least one tongue, and the complementary attachment means comprise a socket.

8. The air deflector insert component of claim 7 wherein the attachment means comprises a plurality of tongues separated by slots, and the above mentioned at least one tongue of the plurality of tongues includes a cusp, and the socket has at least one opening within the socket sized to receive the cusp upon assembly.

9. The air deflector insert component of claim 8 wherein the cusp on the tongue passing into the one opening lock together the attachment means and complementary attachment means forming a permanent corner.

10. The air deflector insert component of claim 9 including a plurality of cusps on tongues and a plurality of complementary openings.

11. The air deflector insert component of claim 6 wherein the attachment means and complementary attachment means comprise at least one pair of complementary protrusions, each protrusion having a hole therethrough, and a pin adapted to be inserted through both holes.

12. The air deflector insert component of claim 11, wherein the holes in the protrusions and the pin are sized for an interference fit therebetween to provide a permanent corner attachment.

13. The air deflector insert component of claim 11 including a corner bracket to lock the corner in place.

14. A method of assembling a plurality of air deflector insert components to form an air deflector insert mountable in an opening formed by grid members in a suspended grid ceiling, said components including opposed ends respectively having attachment means and complementary attachment means comprising the steps of:
connecting by hand manipulation the attachment means of one component to the complementary attachment means of a second component to form a corner, and
repeating the first step for additional corners until the polygonal shape of the air deflector insert is complete.

15. The method of claim 14, including the insertion of a pin in connecting the attachment means to the complementary attachment means.

16. The method of claim 15, including the addition of a corner bracket to the pinned corner.
